(19) United States
(12) Patent Application Publication
(10) Pub. No.: US 2026/0077734 A1
(43) Pub. Date: Mar. 19, 2026

(54) VEHICLE OCCUPANT RESTRAINING SYSTEM AND METHOD FOR CONTROLLING AT LEAST ONE BELT RETRACTOR OF SUCH A VEHICLE OCCUPANT RESTRAINING SYSTEM

(71) Applicant: ZF AUTOMOTIVE GERMANY GMBH, Alfdorf (DE)

(72) Inventors: Steffen HUBER, Schwäbisch Gm¿nd (DE); Wolfgang HOLBEIN, Alfdorf (DE); Franz EIGL, Schwäbisch Gmünd (DE); Bernhard ZEUMER, Wernau (DE)

(21) Appl. No.: 19/109,631

(22) PCT Filed: Sep. 4, 2023
(86) PCT No.: PCT/EP2023/074165

§ 371 Date: Mar. 7, 2025

(30) Foreign Application Priority Data
Sep. 8, 2022 (DE) 10 2022 122 817.7

(51) Int. Cl. B60R 21/0132; B60R 21/01

(52) U.S. Cl. CPC B60R 21/0132; B60R 2021/01272; B60R 2021/01327

(57) ABSTRACT

The invention suggests a vehicle occupant restraint system (10), comprising central sensor electronics (14) which can generate a locking signal; at least one belt retractor (12) which includes an electromechanical locking system (20); drive electronics (22) which is assigned to and can activate the locking system (20) of the belt retractor (12) in reaction to a locking signal; a bus system (16) to which the sensor electronics (14) and the drive electronics (22) are connected; and a line (18) separate from the bus system (16) which connects the drive electronics (22) to the sensor electronics (14). Further, a method of controlling at least one belt retractor (12) of a vehicle occupant restraint system (10) is suggested in which the following steps are provided:
a vehicle acceleration is detected by sensor electronics (14);
if the vehicle acceleration exceeds a predetermined threshold, a locking signal is transmitted via a bus system (16) and via a line (18) separate from the bus system (16) to drive electronics (22, 26) which is assigned to an electromechanical locking system of the belt retractor (12),
the electromechanical locking system (1) then locks the belt reel.

### TECHNICAL FIELD

The invention generally relates to the field of safety of vehicle occupants and of belt retractors for automotive vehicles. In particular, the invention relates to a vehicle occupant restraint system and a method of controlling at least one belt retractor of such a vehicle occupant restraint system.

### BACKGROUND

Belt retractors are used to provide vehicle occupants with a seatbelt so that, in a critical vehicle condition, the vehicle occupant is involved in the deceleration of the vehicle as early as possible. For this purpose, a belt reel which the seatbelt can be wound off and, resp., onto which it can wound again can be locked depending on external parameters. This can be done mechanically, such as by inertia sensors. Also, electromechanical locking systems are known by which the belt reel is locked in response to an electric locking signal.

In order to generate the locking signal, sensor and drive electronics is required which can measure and evaluate the vehicle acceleration and can drive the electromechanical locking system, if necessary.

It is basically conceivable to assign separate sensor and drive electronics to each belt retractor. This results in high costs, however.

It would also be conceivable, however, to make use of the sensor system that is provided in airbag and brake control devices with ESP function in vehicles today. This sensor system is suitable, in terms of measuring range, accuracy and signal bandwidth, also for driving electromechanical systems for locking belt retractors. It would only be necessary to connect the belt retractor via which the sensor system provides the signals for an inflator of an airbag system, for example.

However, the maximum signal latency of bus systems in vehicles is such that the transmission period of the existing sensor data and/or a locking request is not sufficiently fast for all scenarios so that a short time interval until the belt reel is locked, comparable to mechanical systems, can be ensured by an electromechanical locking system.

### SUMMARY

It is the object of the invention to transmit a locking signal to an electromechanical locking system of a belt retractor fast and with still acceptable effort, if there is a vehicle situation in which the belt reel of the belt retractor is to be locked.

According to the invention, to achieve this object, a vehicle occupant restraint system is provided comprising central sensor electronics which can generate a locking signal, at least one belt retractor which includes an electromechanical locking system, drive electronics which is assigned to and can activate the locking system of the belt retractor in reaction to a locking signal, a bus system to which the sensor electronics and the drive electronics are connected, and a line separate from the bus system which connects the drive electronics to the sensor electronics. The invention is based on the fundamental idea to make use, for locking the belt retractor, of a locking signal that is provided by central sensor electronics (i.e. sensor electronics which is also used by other systems, particularly by an airbag system and/or an ESP system) and to transmit said signal via a communication channel that is separate from the bus system (and is thus faster) to the drive electronics. The bus system can be used as a fallback level in case that the locking signal cannot be transmitted via the dedicated signal line. In other words, the problem of the total transmission time (end-to-end-delay) can be avoided by using a second fast communication channel separate from the bus system for the transmission of the locking signal, as the major part of the influencing factors of bus systems causing latency (e.g. message length, waiting time until bus is free, maximum baud rate) is omitted. In addition, the redundant transmission also offers the advantage of the diagnostic capability.

The drive electronics can be assigned to the locking system of plural belt retractors, in particular when belt retractors without a reversible (e.g. electromotive) belt tensioning mechanism, viz. belt retractors which require no complex drive electronics, are concerned.

The belt retractors also can be those which include a belt tensioning mechanism. In this case, the drive electronics is preferably intended to be also used for driving the belt tensioning mechanism. In particular, the drive of the electromechanical locking system can be integrated into the drive electronics for the belt tensioning mechanism so that the mounting effort remains substantially unchanged. There is only required a further signal contact on a printed circuit board of the drive electronics to connect the line which can transmit the locking signal.

In the case of a reversible electromechanical belt retractor and, resp., a reversible electromechanical belt tensioner, the drive electronics, which can be referred to as output stage in the context of the present disclosure, can be directly integrated in the belt retractor and/or in the locking system. Actuators of the locking system can be connected directly-without a wiring harness—to the output stage on the belt retractor.

This can result in the following advantages. A separate actuator ECU can be dispensed with. Additional cores of the fast communication channel can be integrated into the existing plug connection of the belt retractor and/or belt tensioner ECU. A vehicle occupant restraint system of this type can help achieve a simplification of the wiring harness in the vehicle. Due to the short line lengths between the drive electronics and the locking system, it is easier to meet the EMC requirements.

The sensor electronics used to generate the locking signal can also be used to drive an airbag system and/or an ESP system. In general, the sensor electronics can be a control device that is used in vehicles to provide a signal for an airbag system, an ESP system, pre-crash systems etc. in critical vehicle situations.

For achieving the above-mentioned object, also a method of controlling at least one belt retractor of a vehicle occupant restraint system is provided in which a vehicle acceleration is detected by sensor electronics. If the vehicle acceleration exceeds a predetermined threshold or curve, a locking signal is transmitted via a bus system and via a line separate from the bus system to drive electronics which is assigned to an electromechanical locking system of the belt retractor. The electromechanical locking system then locks the belt reel. As regards the resulting advantages, reference is made to the foregoing explanations which are equally applicable both to the method and to the vehicle occupant restraint system.

The locking signal which is transmitted via the line separate from the bus system can be voltage-coded and/or current-coded. It is also possible that the locking signal is pulse width modulated. This allows to transmit a locking signal that can be clearly identified by the drive electronics.

Preferably, a signal is permanently transmitted via the line, with the non-locking signal being different from the locking signal in terms of the pulse width. In this way, it can be easily checked whether the line is basically available for signal transmission.

According to a preferred embodiment, the signal is permanently monitored, wherein, depending on the detected signal, no action is taken, a warning signal is output or, for safety reasons, the signal is interpreted as a locking signal. In this way, particularly high functional reliability can be obtained. In particular, it is possible that the drive electronics activates the electromechanical locking system, when a signal condition is detected that is not clearly identified as “no locking signal”.

The drive electronics can further be arranged to detect different signal amplitudes of the signal for voltage-coded or current-coded signals. Different signal amplitudes can meet different requirements: such as for “locking requested” and for “no locking requested”. Moreover, tolerance bands can be defined. In the amplitude ranges, it is differentiated between two tolerance bands, i.e. between the amplitude ranges “locking requested” and “no locking requested”.

The signal can assume the curve of a function defined in sections. The signal can change gradually over time from a higher voltage and/or current value to a lower voltage and/or current value.

According to one embodiment, the drive electronics is further arranged to drive the electrical locking system of the at least one belt retractor on the basis of a duty cycle of the signal and at least one predefined tolerance range.

The duty cycle of the signal can be defined as follows:

$$D = t / T$$

wherein t is the nominal value of the signal, i.e. the time in which the signal has a higher voltage and/or a higher current, and wherein T can define the period of the signal. The definition of the duty cycle can be explained in detail by way of the figures as described below.

Consequently, the drive electronics can be arranged to request a locking of the belt retractor in a tolerance range of the duty cycle. For a tolerance range of the duty cycle of approx. 60% to 80% a locking can be requested, for example. For a tolerance range of the duty cycle of approx. 30% to 60%, the drive electronics can be arranged to request no locking.

It is also possible that the drive electronics receives status information via the bus system. It can be transmitted to the drive electronics which belt retractor of a vehicle is used, for example based on a plug signal of the belt buckle associated with the belt retractor. In this way, the locking system can only trigger locking, for example, when the respective seat is occupied. On the basis of the status information, the activation of the locking system can be restricted to occupied seats.

All of the foregoing explanations about the vehicle occupant restraint system are equally applicable also to a method of controlling at least one belt retractor of a vehicle occupant restraint system.

### BRIEF DESCRIPTION OF THE DRAWINGS

Hereinafter, embodiments of the invention shall be described with reference to the Figures.

FIG. 1 shows a vehicle occupant restraint system according to one embodiment.

FIG. 2 shows a vehicle occupant restraint system according to another embodiment.

FIGS. 3a and 3b show a signal curve of a signal according to one embodiment.

FIGS. 4a and 4b show a signal curve of a signal according to one embodiment.

FIGS. 5a and 5b show a signal curve of a signal according to one embodiment.

FIG. 6 shows a signal curve of a signal according to one embodiment.

### DESCRIPTION

Similar, similarly acting, like or equally acting elements are provided with similar or like reference signs in the Figures. The Figures are only schematic and not to scale.

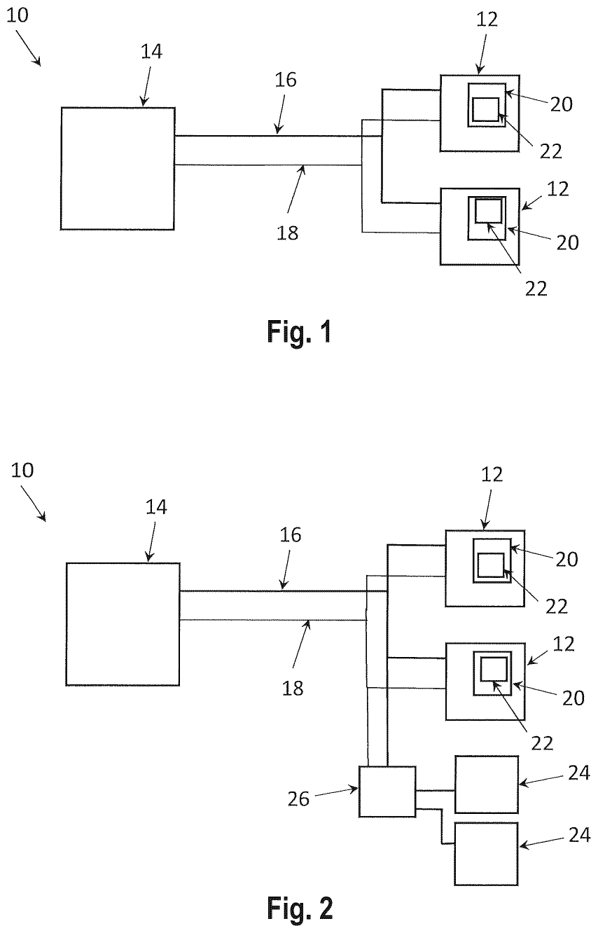

FIG. 1 illustrates a vehicle occupant restraint system 10 according to one embodiment. The vehicle occupant restraint system 10 of FIG. 1 includes plural (only schematically represented) belt retractors 12, sensor electronics 14, a bus system 16 and a line 18 separate from the bus system 16.

The belt retractors 12 are used to provide a vehicle occupant of an automotive vehicle with a seatbelt which can be wound off and wound onto a belt reel.

The belt retractor 12 includes an electromechanical locking system 20 that can latch the belt reel in response to an external locking signal so that no seatbelt can be extracted.

Details of the structure of the locking system 20 as well as of the belt retractor 12 are not relevant to the comprehension of the invention so that they will not be further explained here.

The belt retractor 12 also includes a belt tensioning mechanism by which the belt reel can be rotated, if needed, in the winding direction of the seatbelt. The belt tensioning mechanism can be a so-called power tensioner which before a collision generates a high belt force, or a so-called comfort tensioner which pretensions the seatbelt by moderate forces in the event of strong deceleration, for example. A power tensioner usually operates irreversibly, whereas a comfort tensioner operates reversibly. A power tensioner generally uses a gas generator as a power source, while a comfort tensioner generally uses an electric motor as a drive. In this case, too, details of the structure of the belt tensioning mechanism are not relevant so that they will not be explained in greater detail here.

Within the scope of the invention, it is only relevant that the belt retractor 12 is provided with drive electronics 22 which serves to drive the belt tensioning mechanism. It is connected to the bus system 16.

The sensor electronics 14 is a control device as it is used in particular to drive airbag systems and ESP systems. It monitors the accelerations (of a positive and negative nature) acting upon the vehicle and, once they exceed a predetermined threshold or a predetermined curve, generates a locking signal which indicates that the belt retractor 12 should be locked. The sensor electronics 14, too, is connected to the bus system 16.

The bus system 16 is a common vehicle bus system such as a CAN bus.

The line 18 is a preferably single-core line that is separate from the bus system 16. The line is connected to a signal output of the sensor electronics 14 and to a signal input of the drive electronics 22.

FIG. 2 illustrates a vehicle occupant restraint system 10 according to a further embodiment. Unless otherwise described, the system of FIG. 2 includes the same elements and/or components as the vehicle occupant restraint system 10 of FIG. 1.

In the embodiment of FIG. 2, two belt retractors 24 which have no reversible belt tensioning mechanism are shown in addition to the belt retractors 12. Said belt retractors 24 require no separate drive electronics to take over the more complex tasks of driving a belt tensioning mechanism. Instead, there is provided external drive electronics 26 which is assigned to plural belt retractors 26 in common and the task of which is to drive the electromechanical locking mechanism of the belt retractors 26.

The drive electronics 26 is connected to the line 18 and the bus system 16 in the same way as the drive electronics 26 integrated in the belt retractors 12.

If the sensor electronics 14 detects a vehicle condition that makes it appropriate to lock the belt reels of the belt retractors 12, 24, the sensor electronics 14 provides a locking signal. The latter is transmitted both via the line 18 and via the bus system 16. The locking signal transmitted via the line 18 arrives at the drive electronics 26 without delay, while the locking signal transmitted via the bus system 16 arrives at the drive electronics 26 with the delay inevitable in a bus system.

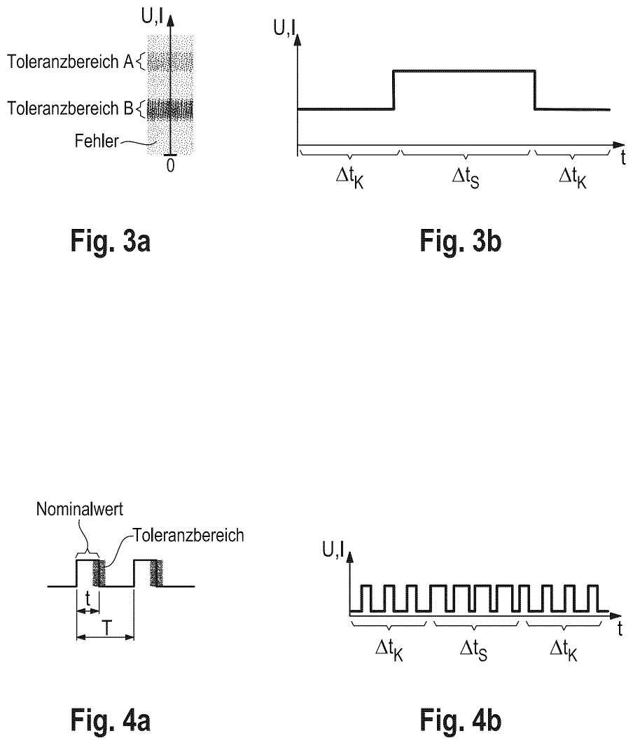

In FIGS. 3a and 3b, a voltage-coded or current-coded locking signal is shown that is generated by the sensor electronics 14. The corresponding signal can be transmitted via the bus system 16 and voltage-coded or current-coded via the line 18.

On the vertical axis of FIG. 3b, i.e. the y-axis, the voltage U or the current I of the signal is plotted over time (x-axis). On the horizontal axis of FIG. 3b, i.e. the x-axis, the time t is shown. The time curve of the signal can be subdivided into three sections. In a first and a last section Δtk, the signal has a lower voltage or a lower current than in the section Δts which denotes a section with higher voltage or higher current. The drive electronics 22 is arranged to interpret the signal based on the amplitude of the voltage or the current.

In particular, the drive electronics 22 can interpret or evaluate the section Δts as a locking signal. The sections Δtk can be interpreted such that no locking of the belt retractor is requested.

In a predefined tolerance range A for the voltage and/or for the current, the drive electronics 22 can interpret the signal as a request for locking. In a further predefined tolerance range B for the voltage and/or the current of the signal, the drive electronics 22 can interpret the signal as a request to perform no locking. If the voltage or the current of the signal is outside the two tolerance ranges A and B, the drive electronics 22 can interpret the signal as a fault.

FIGS. 4a and 4b illustrate a signal curve of a signal according to a further embodiment in which the locking signal is transmitted with pulse width modulation.

The signal of the signal curve of FIGS. 4a and 4b can be transmitted digitally. Different duty cycles can be interpreted as a request of locking or a request of no locking. In this case, too, tolerance bands for both duty cycles can be defined. All values outside said tolerance bands can be interpreted as faults. The duty cycle of the signal can be defined as follows:

$$D = t / T$$

wherein t is the nominal value of the signal, i.e. the time period in which the signal has a higher voltage and/or a higher current, and wherein T can define the period of the signal.

Similarly to FIG. 3b, in FIG. 4b also sections can be defined which can be interpreted as a request of locking or not as a request of locking. In the sections Δtk no locking of the belt retractor is requested, wherein a locking of the belt retractor is requested in section Δts.

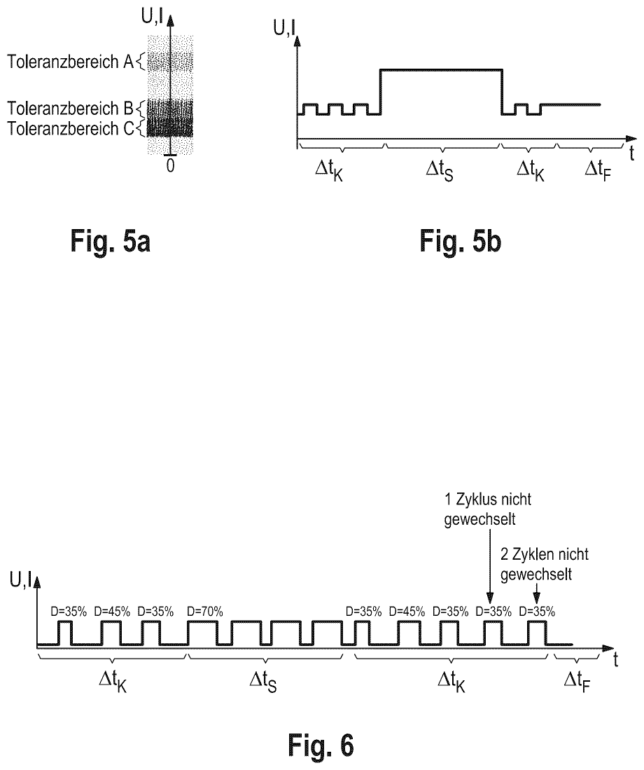

FIGS. 5a and 5b illustrate a signal curve of a signal according to a further embodiment. In this case, too, the signal is transmitted with pulse width modulation. Additionally, an extended protection is provided.

The integrity of the signal “no locking” is further protected by the fact that the signal range is divided into two ranges and the signal has to change at cyclic intervals between said two signal ranges. If no change to the other signal range takes place within a certain period of time, this is interpreted as a fault. Therefore, plural tolerance ranges can be defined for “no locking”. For example, FIG. 5a shows two tolerance ranges B and C which are not connected to a request of a locking of the belt retractor. The time section ΔtF in which no change to the other signal range takes place is interpreted as a fault.

In this way, for example faults can be diagnosed for which the output function in the sensor electronics 14 or the input function in the drive electronics 22 was not cyclically retrieved and, consequently, the signal value was not updated.

FIG. 6 illustrates a signal curve of a signal according to yet another embodiment. In this case, a pulse width modulated signal is permanently transmitted by the sensor electronics 14, with a duty cycle of 70% being identified as a locking signal.

Extended protection is also given for the signal of FIG. 6. It consists in the fact that the duty cycles in the time sections outside the locking signal, viz. in the “normal condition”, change the duty cycles between two values. In the example, it is changed between 35% and 45%.

In this case, too, tolerance ranges can be defined. The tolerance ranges can be defined as follows.

TABLE 1

| | Duty cycle with tolerance range |
|---|---|
| Tolerance range A | 60-80% |
| Tolerance range B | 40-50% |
| Tolerance range C | 30-40% |

1-10. (canceled)

11. A vehicle occupant restraint system (10) comprising central sensor electronics (14) which can generate a locking signal;
at least one belt retractor (12) which includes an electromechanical locking system (20);
drive electronics (22) which is assigned to and can activate the locking system (20) of the belt retractor (12) in reaction to a locking signal;
a bus system (16) to which the sensor electronics (14) and the drive electronics (22) are connected; and
a line (18) separate from the bus system (16) which connects the drive electronics (22) to the sensor electronics (14).

12. The vehicle occupant restraint system (10) according to claim 11, wherein the drive electronics (22) is assigned to plural belt retractors (12).

13. The vehicle occupant restraint system (10) according to claim 11, wherein the belt retractor (12) includes a reversible belt tensioning mechanism.

14. The vehicle occupant restraint system (10) according to claim 13, wherein the drive electronics (22) also serves to drive the reversible belt tensioning mechanism.

15. The vehicle occupant restraint system (10) according to claim 11, wherein the sensor electronics (14) is also used to drive an airbag system and/or an ESP system.

16. A method of controlling at least one belt retractor (12) of a vehicle occupant restraint system (10), particularly a vehicle occupant restraint system (10) according to claim 11, comprising the following steps:
a vehicle acceleration is detected by sensor electronics (14);
if the vehicle acceleration exceeds a predetermined threshold or curve, a locking signal is transmitted via a bus system (16) and via a line (18) separate from the bus system (16) to drive electronics (22, 26) which is assigned to an electromechanical locking system of the belt retractor (12),
the electromechanical locking system (20) then locks the belt reel.

17. The method according to claim 16, wherein the locking signal is voltage-coded and/or current-coded.

18. The method according to claim 16, wherein the locking signal is pulse width modulated.

19. The method according to claim 18, wherein a signal is permanently transmitted via the line (18), wherein the non-locking signal differs from the locking signal in terms of the pulse width.

20. The method according to claim 19, wherein the signal is permanently monitored and, depending on the detected signal, no action is taken, a warning signal is output or, for safety reasons, the signal is interpreted as a locking signal.
